(19) United States
(12) Patent Application Publication
(10) Pub. No.: US 2017/0370317 A1
(43) Pub. Date: Dec. 28, 2017

(54) ABNORMALITY DIAGNOSIS DEVICE FOR PM SENSOR

(71) Applicant: DENSO CORPORATION, Kariya-city, Aichi-pref. (JP)

(72) Inventors: Hiroaki FUJII, Kariya-city (JP); Shingo NAKATA, Kariya-city (JP)

(21) Appl. No.: 15/544,044

(22) PCT Filed: Jan. 13, 2016
(86) PCT No.: PCT/JP2016/000133

§ 371 Date: Jul. 17, 2017

(30) Foreign Application Priority Data
Jan. 20, 2015 (JP) 2015-008401

(51) Int. Cl. F02D 41/22; F01N 3/021; F02D 41/40; F02D 41/38; F01N 11/00; F02D 41/26

(52) U.S. Cl. CPC F02D 41/222; F02D 41/3836; F01N 11/00; F01N 3/021; F02D 41/402; F02D 41/401; F02D 41/26; F01N 2560/05; F02D 2200/0812

(57) ABSTRACT

A PM sensor is arranged downstream of a one-side blocked filter that collects a particulate matter in exhaust gas of an engine, and first and second sensor abnormality diagnoses are executed based on output of the PM sensor. In the first sensor abnormality diagnosis, a filter-outflow PM amount (an amount of the PM flowing out from the one-side blocked filter) is estimated based on a working condition of the engine and a PM collection rate of the one-side blocked filter, and an occurrence of output abnormality of the PM sensor is determined by comparing a sensor-detection PM amount (an amount of the PM detected based on the output of the PM sensor) with the filter-outflow PM amount. In the second sensor abnormality diagnosis, an engine discharging PM amount (an amount of the PM discharged from the engine) is estimated based on a working condition of the engine, and an occurrence of output abnormality of the PM sensor is determined by comparing an increasing rate of the output of the PM sensor with an increasing rate of the engine discharging PM amount.

### CROSS REFERENCE TO RELATED APPLICATIONS

This application is based on Japanese Patent Application No. 2015-8401 filed on Jan. 20, 2015, the disclosure of which is incorporated herein by reference.

### TECHNICAL FIELD

The present disclosure relates to an abnormality diagnosis device for a PM sensor that detects a particulate matter (PM) in exhaust gas of an internal combustion engine.

### BACKGROUND ART

In the internal combustion engine mounted to a vehicle, it is expected that increment in demand of a direct injection gasoline engine in accordance with tightening a fuel regulation. However, in the direct injection gasoline engine, an exhaust amount of the particulate matter (PM) is larger than that of the port injection gasoline engine. As a countermeasure, a configuration in which a filter that collects the PM exhausted from the engine is arranged in an exhaust passage in the engine has been known.

In such a system including the filter for collecting the PM, a configuration in which a PM sensor that detects an amount of the PM in the exhaust gas is arranged downstream of the filter for collecting the PM, and occurrence of failure of the filter is determined based on the amount of the PM detected by the PM sensor has been known.

Further, as a technique of an abnormality diagnosis of the PM sensor, a configuration disclosed in, for example, Patent Literature 1 (JP 2012-013058 A) is known. In a system in which the PM sensor is arranged downstream of the filter for collecting the PM, it is determined by the technique of an abnormality diagnosis of the PM sensor that the failure of the PM sensor is occurred when an output value of the PM sensor is always “0” while a recovery control to burn and eliminate the PM collected by the filter is suspending.

Further, in a conventional filter for collecting the PM, a configuration in which an inlet side of a part of cells arranged in the filter is blocked and an outlet side of the remaining cells (namely, cells with inlet side opened) is blocked is known.

In the conventional filter described above, since a collection rate of the PM is kept at substantially 100% (see FIG. 5) and the PM hardly flows out from the filter after a PM accumulation amount is increased, the output of the PM sensor is kept at around “0” (see FIG. 6) even if the PM sensor downstream of the filter is normal. Thus, in a system in which the PM sensor is arranged downstream of the conventional filter, it is difficult to determine whether the output of the PM sensor is normal, and therefore it is difficult to detect output abnormality of the PM sensor.

### PRIOR ART LITERATURES

### Patent Literature

Patent Literature 1: JP 2012-013058 A

### SUMMARY OF INVENTION

It is an object of the present disclosure to provide an abnormality diagnosis device for a PM sensor capable of detecting output abnormality of the PM sensor easily.

According to one aspect of the present disclosure, an abnormality diagnosis device for a PM sensor includes: a one-side blocked filter that collects a particulate matter (hereinafter, referred to as “PM”) in exhaust gas of an internal combustion engine, the filter having a structure in which an inlet side of a part of cells arranged in the filter is blocked and an outlet side of at least of one cell among the remaining cells is opened, or a structure in which the outlet side of a part of the cells is blocked and the inlet side of at least one cell among the remaining cells is opened; a PM sensor that detects an amount of the PM in the exhaust gas passed through the one-side blocked filter; and an abnormality diagnosis part that executes a sensor abnormality diagnosis that determines occurrence of output abnormality of the PM sensor based on output of the PM sensor.

In the one-side blocked filter, since a PM collection rate is kept to have a lower collection rate (collection rate lower than 100%) than that of a conventional filter (see FIG. 5) and the PM flows out from the one-side blocked filter, when the PM sensor downstream of the one-side blocked filter is normal, the output of the PM sensor indicates a value larger than “0” (a value corresponding to the amount of the PM flowing out from the one-side blocked filter) (see FIG. 6). Accordingly, in the system in which the PM sensor is arranged downstream of the one-side blocked filter, it is possible to determine the occurrence of the output abnormality of the PM sensor by monitoring the output of the PM sensor, and therefore the output abnormality of the PM sensor can be detected easily.

In this case, it is preferable that an outflow PM amount estimation part that estimates the amount of the PM flowing out from the one-side blocked filter (hereinafter, referred to as “filter-outflow PM amount”) based on a working condition of the internal combustion engine and the PM collection rate of the one-side blocked filter is arranged and the abnormality diagnosis part executes the sensor abnormality diagnosis by comparing an amount of the PM detected based on the output of the PM sensor (hereinafter, referred to as “sensor-detection PM amount”) with the filter-outflow PM amount estimated by the outflow PM amount estimation part.

When the output of the PM sensor is normal, the sensor-detection PM amount and the filter-outflow PM amount are roughly matched with each other. Accordingly, by comparing the sensor-detection PM amount with the filter-outflow PM amount, the occurrence of the output abnormality (abnormality of the output value) of the PM sensor can be precisely determined.

Further, it is preferable that a discharging PM amount estimation part that estimates an amount of the PM discharged from the internal combustion engine (hereinafter, referred to as “internal combustion engine discharging PM amount”) based on a working condition of the internal combustion engine is arranged and the abnormality diagnosis part executes the sensor abnormality diagnosis by comparing a change rate of the output of the PM sensor with a change rate of the internal combustion engine discharging PM amount estimated by the discharging PM amount estimation part.

As the amount of the PM discharged from the internal combustion engine is changed, the amount of the PM flowing out from the one-side blocked filter is changed, and the output of the PM sensor is changed, and therefore when the output of the PM sensor is normal, the change rate of the output of the PM sensor and the change rate of the internal combustion engine discharging PM amount are roughly matched with each other. Accordingly, by comparing the change rate of the output of the PM sensor with the change rate of the internal combustion engine discharging PM amount, the output abnormality (linearity abnormality of the output) of the PM sensor can be precisely determined.

### BRIEF DESCRIPTION OF DRAWINGS

The above and other objects, features, and advantages of the present disclosure will become more apparent from the following detailed description made with reference to the accompanying drawings.

FIG. 1 is a diagram illustrating a schematic configuration of an engine control system according to one embodiment of the present disclosure.

FIG. 2 is a cross-sectional view of a one-side blocked filter along an exhaust gas flow direction.

FIG. 3 is a cross-sectional view of an inlet side of the one-side blocked filter along a direction orthogonal to the exhaust gas flow direction.

FIG. 4 is a cross-sectional view of an outlet side of the one-side blocked filter along the direction orthogonal to the exhaust gas flow direction.

FIG. 5 is a diagram illustrating a relationship between a PM accumulation amount and a PM collection rate.

FIG. 6 is a time chart illustrating behavior of an output of a PM sensor.

FIG. 7 is a diagram illustrating an estimation method of an engine discharging PM amount.

FIG. 8 is a diagram illustrating a first sensor abnormality diagnosis.

FIG. 9 is a diagram illustrating a second sensor abnormality diagnosis.

FIG. 10 is a flowchart illustrating processing of a first sensor abnormality diagnosis routine.

FIG. 11 is a flowchart illustrating processing of a second sensor abnormality diagnosis routine.

### EMBODIMENT FOR CARRYING OUT INVENTION

Hereinafter, one embodiment that embodies a configuration carrying out the present disclosure is described.

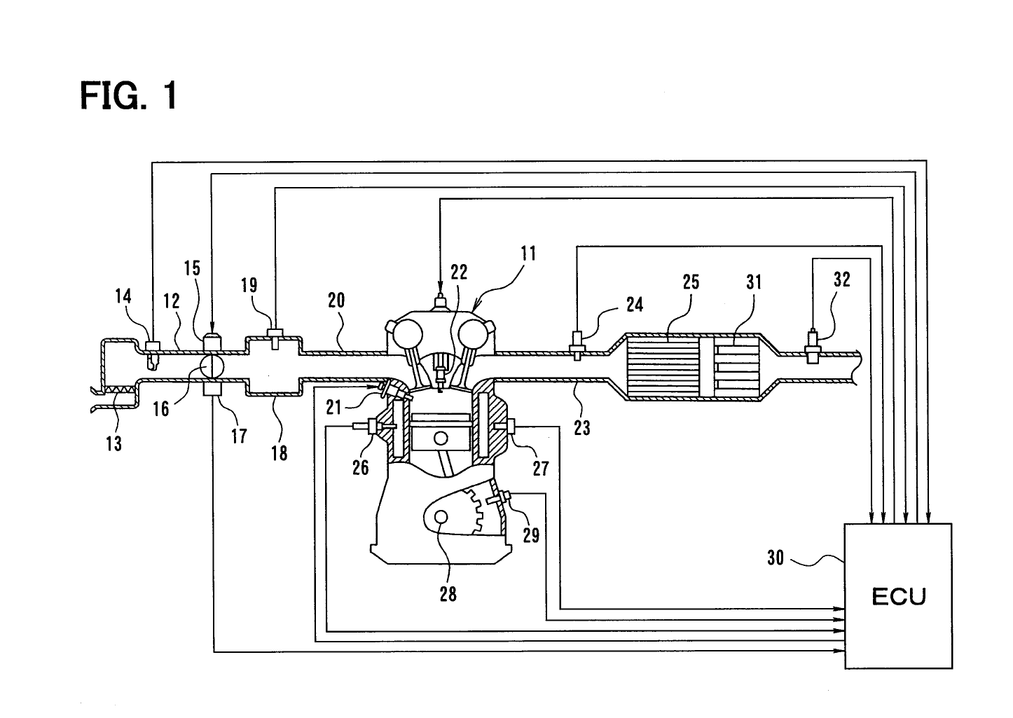

At first, a schematic configuration of an engine control system is described with reference to FIG. 1.

An engine 11 as a direct injection internal combustion engine is formed as a direct injection gasoline engine that directly injects gasoline as fuel into a cylinder. An air cleaner 13 is arranged at the most upstream part of an inlet pipe 12 of the engine 11, and an air flow meter 14 that detects an intake air amount is arranged at a downstream side of the air cleaner 13. A throttle valve 16 having an opening to be adjusted by a motor 15, and a throttle opening sensor 17 that detects the opening (throttle opening degree) of the throttle valve 16 are arranged downstream of the air flow meter 14.

Further, a serge tank 18 is arranged downstream of the throttle valve 16, and an inlet pipe pressure sensor 19 that detects an inlet pipe pressure is arranged in the serge tank 18. Further, an inlet manifold 20 that introduces air into each cylinder of the engine 11 is arranged in the serge tank 18. A fuel injection valve 21 that directly injects fuel (gasoline) into each cylinder is mounted to each cylinder of the engine 11. Further, an ignition plug 22 is mounted to a cylinder head of the engine 11 so as to correspond to each cylinder, and air-fuel mixture in each cylinder is ignited by spark discharge generated by the ignition plug 22 of each cylinder.

Further, an exhaust gas sensor 24 (air/fuel ratio sensor, oxygen sensor or the like) that detects an air fuel ratio or rich/lean burn of the exhaust gas is arranged in an exhaust pipe 23 of the engine 11, and a catalyst 25 such as three way catalyst that purifies CO, HC, NOₓ, or the like in the exhaust gas is arranged downstream of the exhaust gas sensor 24.

Further, a one-side blocked filter 31 that collects a particulate matter (PM) in the exhaust gas of the engine 11 is arranged downstream of the catalyst 25 in the exhaust pipe 23 of the engine 11. The catalyst 25 and the one-side blocked filter 31 may be housed in a single case, or alternatively may be housed in respective cases. Further, a PM sensor 32 that detects an amount of the PM in the exhaust gas passed through the one-side blocked filter 31 is arranged downstream of the one-side blocked filter 31.

Further, a coolant temperature sensor 26 that detects a temperature of coolant, and a knock sensor 27 that detects a knocking are mounted to a cylinder block of the engine 11. Further, a crank angle sensor 29 that outputs a pulse signal at a predetermined crank angle of a crank shaft 28 is mounted to an outer peripheral part of the crank shaft 28, and a crank angle and an engine speed are detected based on the output signal of the crank angle sensor 29.

Outputs of these various sensors are input to an electronic control unit 30 (hereinafter, referred to as “ECU”). The ECU 30 is mainly provided with a microcomputer. The ECU 30 controls a fuel injection amount, an ignition timing, a throttle opening (inlet air amount) and the like in accordance with a driving state of the engine by executing various programs for controlling the engine stored in an embedded ROM (storage medium).

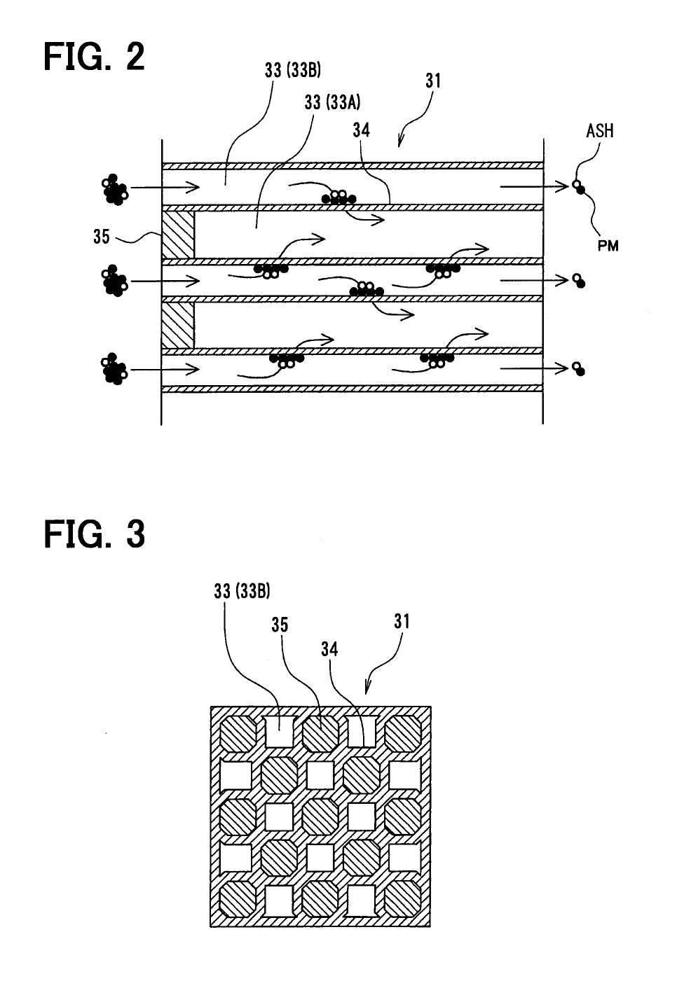

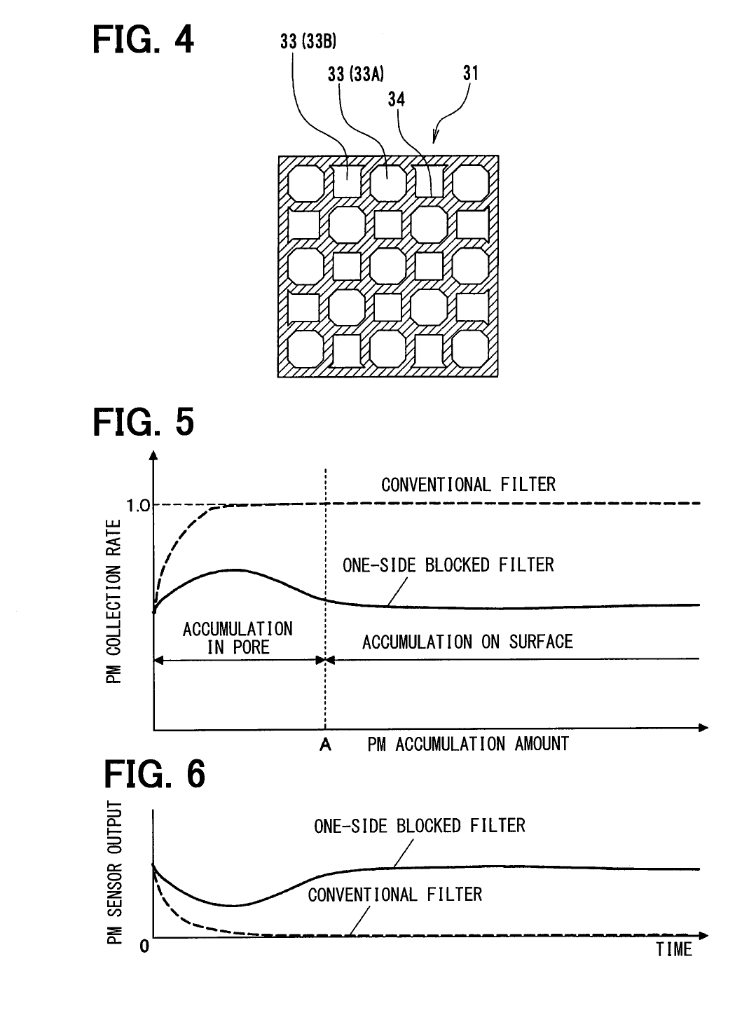

As shown in FIG. 2 to FIG. 4, the one-side blocked filter 31 has a structure in which cells 33 extended in an exhaust gas flow direction (direction from an inlet side toward an outlet side) are partitioned by a porous partition wall 34 (partition wall) and an end part of the inlet side of a part of cells 33 is blocked by a blocking member 35 and the outlet side of all of the cells 33 is opened. In the present embodiment, a cell 33A in which the inlet side is blocked and the outlet side is opened (hereinafter, referred to as “inlet-side blocked cell”) and a cell 33B in which both of the inlet side and the outlet side are opened (hereinafter, referred to as “both-sides open cell”) are arranged alternately so as to be adjacent to each other.

In the one-side blocked filter 31, when the exhaust gas flows into the cell 33B through the inlet side of the both-sides open cell 33B, the pressure inside the both-sides open cell 33B is increased and the pressure inside the inlet-side blocked cell 33A becomes relatively low compared to the pressure inside the both-sides open cell 33B. Thus, a part of the exhaust gas from the both-sides open cell 33B passes through the porous partition wall 34 and flows into the inlet-side blocked cell 33A to flow to an outside of the cell 33A from the outlet side of the inlet-side blocked cell 33A. At this time, the PM (for example, SOOT particle having a diameter of 20 nm to 100 nm) in the exhaust gas adheres inside a pore (inner surface of pore) or adheres to a wall surface of the partition wall 34 to be collected. Further, ash as a nonflammable substance (for example, ash content caused by oil of the engine 11) in the exhaust gas also adheres inside the pore or adheres to the wall surface of the partition wall 34 to be collected.

In a system including the one-side blocked filter 31 for collecting the PM, when a PM accumulation amount of the blocked filter 31 (an amount of the PM accumulated in the one-side blocked filter 31) becomes excessively large, the pressure loss of the exhaust becomes larger. Thus, the ECU 30 executes a recovery control in which the PM collected in the one-side blocked filter 31 is burned and eliminated so as to recover the one-side blocked filter 31 (to reduce the PM accumulation amount in the one-side blocked filter 31). As the recovery control, a fuel cut control to be executed when a predetermined fuel cut execution condition is satisfied (for example, during deceleration) may be adopted as an example. Further, when the PM accumulation amount in the one-side blocked filter 31 exceeds a predetermined upper limit, for example, a control in which the air fuel ratio is switched to a lean side or a control in which an exhaust temperature is increased is executed as the recovery control.

As shown in FIG. 5, in the one-side blocked filter 31, after the PM is eliminated by means of the recovery control (after the PM accumulation amount is substantially equal to “0”), the PM is accumulated inside the pore of the partition wall 34 and thereafter the PM is accumulated on the wall surface of the partition wall 34. In an accumulation region in the pore in which the PM is accumulated in the pore of the partition wall 34 (a region in which the PM accumulation amount is relatively small), the PM collection rate is once increased and then decreased in accordance with increment of the PM accumulation amount. After that, in an accumulation region of the wall surface in which the PM is accumulated on the wall surface of the partition wall 34, the PM collection rate becomes substantially constant.

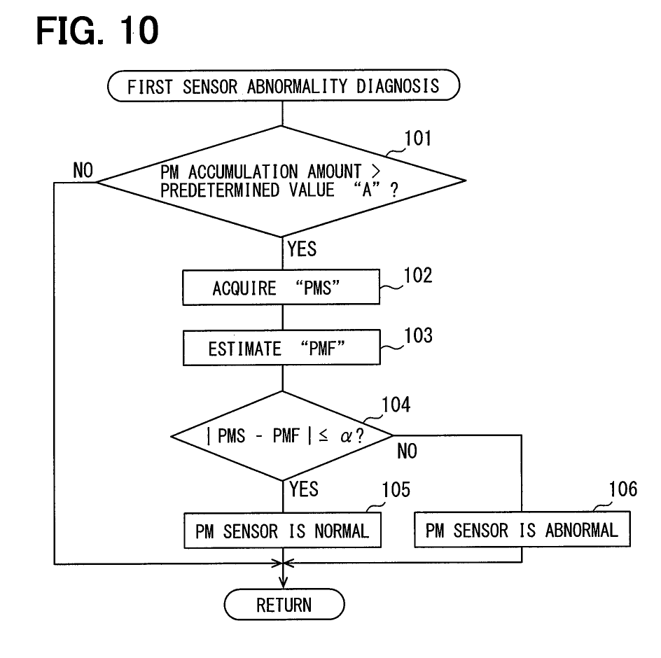

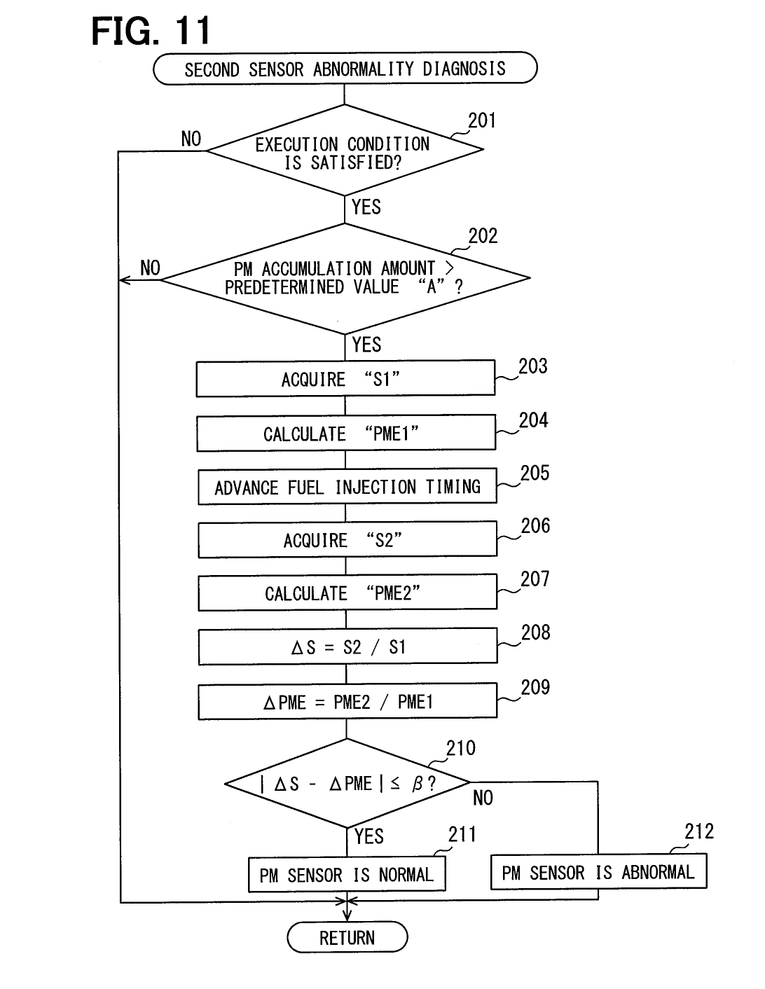

Further, the ECU 30 executes respective routines for sensor abnormality diagnoses shown in FIG. 10 and FIG. 11 described below so as to execute the sensor abnormality diagnosis that determines occurrence of output abnormality of the PM sensor 32 based on output of the PM sensor 32.

In the one-side blocked filter 31, the PM collection rate is kept to have a lower collection rate (collection rate less than 100%) than that of the conventional filter (see FIG. 5), and the PM flows out from the one-side blocked filter 31. Thus, when the PM sensor 32 downstream of the one-side blocked filter 31 is normal, the output of the PM sensor 32 indicates a value larger than “0” (a value corresponding to the amount of the PM flowing out from the one-side blocked filter 31) (see FIG. 6). Accordingly, in the system in which the PM sensor 32 is arranged downstream of the one-side blocked filter 31, it is possible to determine the occurrence of the output abnormality of the PM sensor 32 by monitoring the output of the PM sensor 32, and therefore the output abnormality of the PM sensor 32 can be detected easily.

In the present embodiment, after the PM accumulation amount in the one-side blocked filter 31 exceeds a predetermined value “A” (the PM accumulation amount necessary for stabilizing the PM collection rate), a first sensor abnormality diagnosis is executed by the ECU 30 by executing a first sensor abnormality diagnosis routine shown in FIG. 10 described below. In the first sensor abnormality diagnosis, the filter-outflow PM amount (an amount of the PM flowing out from the one-side blocked filter 31) is estimated based on the working condition of the engine 11 and the PM collection rate of the one-side blocked filter 31, and then the occurrence of the output abnormality of the PM sensor 32 is determined by comparing the sensor-detection PM amount (an amount of the PM detected based on the output of the PM sensor 32) with the filter-outflow PM amount.

When the output of the PM sensor 32 is normal, the sensor-detection PM amount and the filter-outflow PM amount are roughly matched with each other. Accordingly, by comparing the sensor-detection PM amount with the filter-outflow PM amount, the occurrence of the output abnormality (abnormality of the output value) of the PM sensor 32 can be precisely determined.

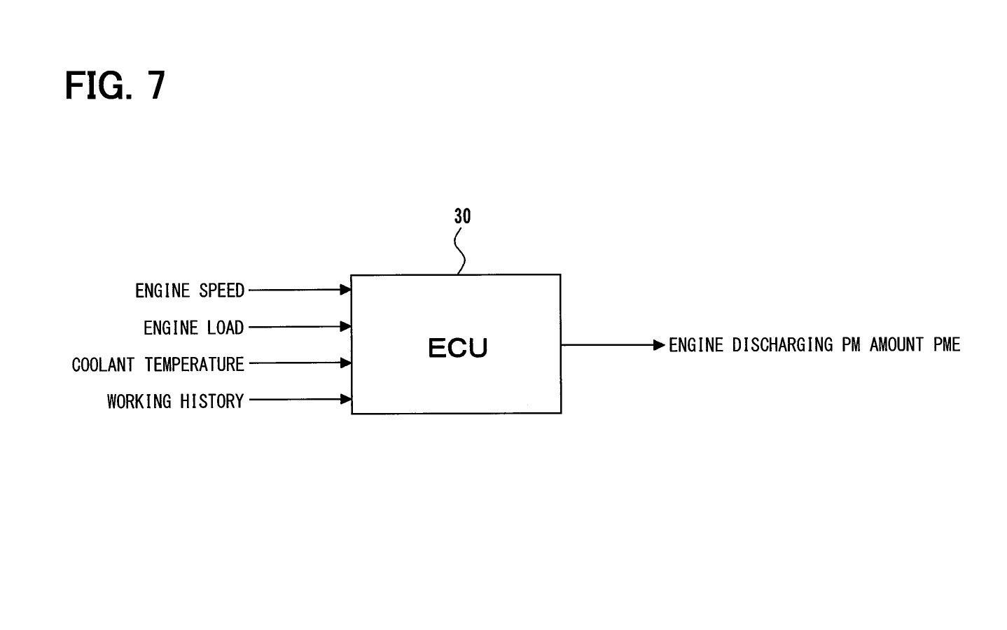

Specifically, in the first sensor abnormality diagnosis, as shown in FIG. 7, based on an engine speed, an engine load (for example, inlet pipe pressure, inlet air amount, or the like), a coolant temperature, a working history or the like, an engine discharging PM amount PME (an amount of the PM discharged from the engine 11) is calculated by a map, a formula, or the like. The map, the formula, or the like of the engine discharging PM amount PME is made based on experimental data, design data, or the like in advance and stored in a ROM of the ECU 30.

Further, based on the working condition of the engine 11, the sensor-detection PM amount, or the like, the PM accumulation amount is calculated by the map, the formula, or the like, and then the PM collection rate is calculated by the map, the formula, or the like in accordance with the PM accumulation amount. Here, in a system having a differential pressure sensor that detects a difference (before and after differential pressure) between an upstream exhaust pressure and a downstream exhaust pressure of the one-side blocked filter 31, the PM accumulation amount may be calculated by a map, a formula, or the like in accordance with output of the differential pressure sensor. The map, the formula, or the like of the PM accumulation amount and the PM collection rate is made by experimental data, design data, or the like in advance and stored in the ROM of the ECU 30.

After that, by using the engine discharging PM amount PME and the PM collection rate, the filter-outflow PM amount PMF is calculated by the following formula.

Filter-outflow PM amount PMF=Engine discharging PM amount PME×(1−PM collection rate)

In this way, after the filter-outflow PM amount PMF is estimated (calculated), based on whether an absolute value |PMS−PMF| of difference between the sensor-detection PM amount PMS and the filter-outflow PM amount PMF is equal to or less than a predetermined value α, it is determined whether the sensor-detection PM amount PMS is within a normal range (range of PMF±α).

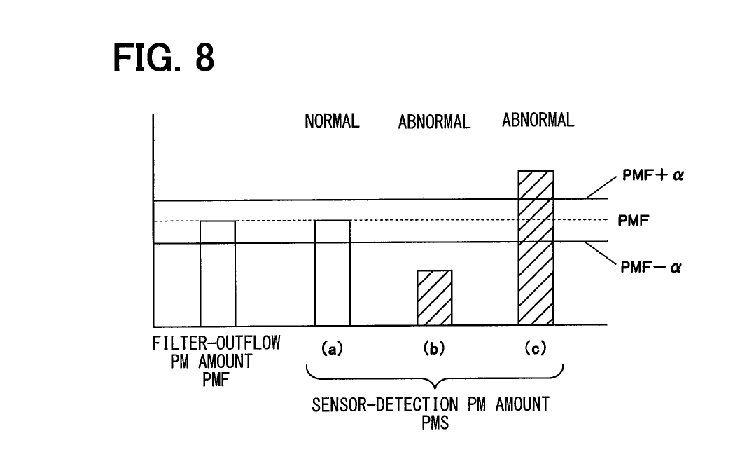

As a result, as shown in (a) in FIG. 8, in a case in which the absolute value |PMS−PMF| of the difference between the sensor-detection PM amount PMS and the filter-outflow PM amount PMF is equal to or less than the predetermined value α, namely the sensor-detection PM amount PMS is within the normal range (range of PMF±α), it is determined that the PM sensor 32 is normal (output abnormality of the PM sensor 32 is not occurred).

Contrary to this, as shown in (b), (c) in FIG. 8, in a case in which the absolute value |PMS−PMF| of the difference between the sensor-detection PM amount PMS and the filter-outflow PM amount PMF exceeds the predetermined value α, namely the sensor-detection PM amount PMS is out of the normal range (range of PMF±α), it is determined that the output abnormality (the abnormality of the output value) of the PM sensor 32 is occurred. At this time, as shown in (b) in FIG. 8, in a case in which the sensor-detection PM amount PMS is smaller than a lower limit (PMF−α) of the normal range, it is determined that the output of the PM sensor 32 is excessively small and the output abnormality of the PM sensor 32 is occurred. On the other hand, as shown in (c) in FIG. 8, in a case in which the sensor-detection PM amount PMS is larger than an upper limit (PMF+α) of the normal range, it is determined that the output of the PM sensor 32 is excessively large and the output abnormality of the PM sensor 32 is occurred.

Further, in the present embodiment, after the PM accumulation amount in the one-side blocked filter 31 exceeds the predetermined value “A” (the PM accumulation amount necessary for stabilizing the PM collection rate), a second sensor abnormality diagnosis is executed by the ECU 30 by executing a second sensor abnormality diagnosis routine shown in FIG. 11 described below. In the second sensor abnormality diagnosis, the engine discharging PM amount (an amount of the PM discharged from the engine 11) is estimated based on the working condition of the engine 11, and then the occurrence of the output abnormality of the PM sensor 32 is determined by comparing a change rate (for example, increasing rate) of the output of the PM sensor 32 with a change rate (for example, increasing rate) of the engine discharging PM amount.

When the PM amount discharged from the engine 11 is changed, the amount of the PM flowing out from the one-side blocked filter 31 is changed and the output of the PM sensor 32 is changed, and therefore when the output of the PM sensor 32 is normal, the change rate of the output of the PM sensor 32 and the change rate of the engine discharging PM amount are roughly matched with each other. Accordingly, by comparing the change rate of the output of the PM sensor 32 with the change rate of the engine discharging PM amount, the occurrence of the output abnormality (linearity abnormality of the output) of the PM sensor 32 can be precisely determined.

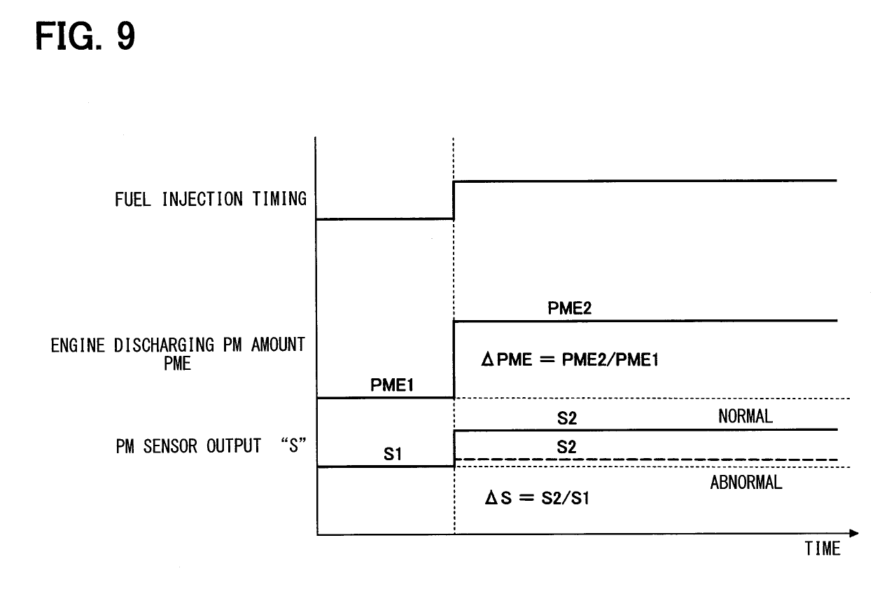

Specifically, in the second sensor abnormality diagnosis, as shown in FIG. 9, before fuel injection timing of the engine 11 is compulsorily changed, output S1 of the PM sensor 32 is read, and based on the working condition of the engine 11 (engine speed, engine load, coolant temperature, working history or the like), an engine discharging PM amount PME1 is calculated by a map, a formula, or the like (see FIG. 7).

And then, after the fuel injection timing of the engine 11 is compulsorily changed (advanced) and the amount of the PM discharged from the engine 11 is compulsorily changed (increased), output S2 of the PM sensor 32 is read, and based on the working condition of the engine 11, an engine discharging PM amount PME2 is calculated by a map, a formula or the like.

After that, an increasing rate ΔS=S2/S1 of the output of the PM sensor 32 is calculated and an increasing rate ΔPME=PME2/PME1 of the engine discharging PM amount is calculated. Further, based on whether an absolute value |ΔS−ΔPME| of difference between the increasing rate ΔS of the output of the PM sensor 32 and the increasing rate ΔPME of the engine discharging PM amount is equal to or less than a predetermined value β, it is determined whether the increasing rate ΔS of the output of the PM sensor 32 is within a normal range (range of ΔPME±β).

As a result, in a case in which the absolute value |ΔS−ΔPME| of the difference between the increasing rate ΔS of the output of the PM sensor 32 and the increasing rate ΔPME of the engine discharging PM amount is equal to or less than the predetermined value β, namely the increasing rate ΔS of the output of the PM sensor 32 is within the normal range (range of ΔPME±β), it is determined that the PM sensor 32 is normal (the output abnormality of the PM sensor 32 is not occurred).

Contrary to this, in a case in which the absolute value |ΔS−ΔPME| of the difference between the increasing rate ΔS of the output of the PM sensor 32 and the increasing rate ΔPME of the engine discharging PM amount exceeds the predetermined value β, namely the increasing rate ΔS of the output of the PM sensor 32 is out of the normal range (range of ΔPME±β), it is determined that the output abnormality (linearity abnormality of the output) of the PM sensor 32 is occurred. At this time, in a case in which the increasing rate ΔS of the output of the PM sensor 32 is smaller than an lower limit (ΔPME−β) of the normal range, it is determined that the increasing rate ΔS of the output of the PM sensor 32 is excessively small and the output abnormality of the PM sensor 32 is occurred. On the other hand, in a case in which the increasing rate ΔS of the output of the PM sensor 32 is larger than an upper limit (ΔPME+β) of the normal range, it is determined that the increasing rate ΔS of the output of the PM sensor 32 is excessively large and the output abnormality of the PM sensor 32 is occurred.

The sensor abnormality diagnosis according to the present embodiment described above is executed by the ECU 30 in accordance with each routine for the sensor abnormality diagnosis shown in FIG. 10 and FIG. 11. Hereinafter, processing in each routine is described.

The first sensor abnormality diagnosis routine shown in FIG. 10 is repeated at a predetermined frequency during a period of power ON of the ECU 30, and the first sensor abnormality diagnosis routine is served as an abnormality diagnosis part.

In Step 101, it is determined whether the PM accumulation amount in the one-side blocked filter 31 exceeds the predetermined value “A” (see FIG. 5). The predetermined value “A” corresponds to the PM accumulation amount necessary for stabilizing the PM collection rate of the one-side blocked filter 31, and for example, the predetermined value “A” is set to a PM accumulation amount when the pore accumulation region is transited to the wall surface accumulation region or an amount slightly larger than the PM accumulation amount.

In Step 101, in a case in which the PM accumulation amount does not exceed the predetermined value “A”, it is determined that the PM collection rate is not stable and this routine is ended without executing processing after Step 102 in the first sensor abnormality diagnosis.

On the other hand, in Step 101, in a case in which the PM accumulation amount exceeds the predetermined value “A”, it is determined that the PM collection rate is stable and the processing after Step 102 in the first sensor abnormality diagnosis is executed in the following way.

In Step 102, the amount of the PM detected based on the output of the PM sensor 32 is acquired as the sensor-detection PM amount.

After that, the processing proceeds to Step 103, and based on the working condition of the engine 11 (engine speed, engine load, coolant temperature, working history, or the like), the engine discharging PM amount PME is calculated by the map, the formula, or the like, and then the filter-outflow PM amount PMF is calculated by the following formula by using the engine discharging PM amount PME and the PM collection rate.

Filter-outflow PM amount PMF=Engine discharging PM amount PME×(1−PM collection rate)

The processing of Step 103 is served as an outflow PM amount estimation part.

After that, the processing proceeds to Step 104, and based on whether the absolute value |PMS−PMF| of the difference between the sensor-detection PM amount PMS and the filter-outflow PM amount PMF is equal to or less than the predetermined value α, it is determined whether the sensor-detection PM amount PMS is within the normal range (range of PMF±α).

In Step 104, in a case in which the absolute value |PMS−PMF| of the difference is equal to or less than the predetermined value α, namely the sensor-detection PM amount PMS is within the normal range (range of PMF±α), the processing proceeds to Step 105, and it is determined that the PM sensor 32 is normal (the output abnormality of the PM sensor 32 is not occurred).

Contrary to this, in Step 104, in a case in which the absolute value |PMS−PMF| of the difference exceeds the predetermined value α, namely the sensor-detection PM amount PMS is out of the normal range (range of PMF±α), the processing proceeds to Step 106, and it is determined that the output abnormality (the abnormality of the output value) of the PM sensor 32 is occurred. At this time, in a case in which the sensor-detection PM amount PMS is smaller than the lower limit (PMF−α) of the normal range, it is determined that the output of the PM sensor 32 is excessively small and the output abnormality of the PM sensor 32 is occurred. On the other hand, in a case in which the sensor-detection PM amount PMS is larger than the upper limit (PMF+α) of the normal range, it is determined that the output of the PM sensor 32 is excessively large and the output abnormality of the PM sensor 32 is occurred.

Further, the second sensor abnormality diagnosis routine shown in FIG. 11 is repeated at a predetermined frequency during the period of the power ON of the ECU 30, and the second sensor abnormality diagnosis routine is served as an abnormality diagnosis part.

When this routine is started, at first in Step 201, it is determined whether a predetermined execution condition is satisfied based on, for example, whether an engine working state is in a normal state or the like.

In Step 201, in a case in which the execution condition is not satisfied, this routine is ended without executing processing after Step 202.

On the other hand, in Step 201, in a case in which the execution condition is satisfied, the processing proceeds to Step 202, and it is determined whether the PM accumulation amount in the one-side blocked filter 31 exceeds the predetermined value “A” (see FIG. 5).

In Step 202, in a case in which the PM accumulation amount does not exceed the predetermined value “A”, it is determined that the PM collection rate is not stable and this routine is ended without executing processing after Step 203 in the second sensor abnormality diagnosis.

On the other hand, in Step 202, in a case in which the PM accumulation amount exceeds the predetermined value “A”, it is determined that the PM collection rate is stable and the processing after Step 203 in the second sensor abnormality diagnosis is executed in the following way.

At first, in Step 203, after output S1 of the PM sensor 32 is acquired, the processing proceeds to Step 204, and based on the working condition of the engine 11 (engine speed, engine load, coolant temperature, working history, or the like), the engine discharging PM amount PME1 is calculated by a map, a formula, or the like. The processing of Step 204 is served as a discharging PM amount estimation part.

After that, the processing proceeds to Step 205, and the fuel injection timing of the engine 11 is compulsorily advanced, and thereby the amount of the PM discharged from the engine 11 is compulsorily increased. After that, the processing proceeds to Step 206, and after output S2 of the PM sensor 32 is acquired, the processing proceeds to Step 207, and based on the working condition of the engine 11, an engine discharging PM amount PME2 is calculated by a map, a formula, or the like. The processing of Step 207 is also served as the discharging PM amount estimation part.

After that, the processing proceeds to Step 208, and after the increasing rate ΔS=S2/S1 of the output of the PM sensor 32 is calculated, the processing proceeds to Step 209, and the increasing rate ΔPME=PME2/PME1 of the engine discharging PM amount is calculated.

After that, the processing proceeds to Step 210, and based on whether the absolute value |ΔS−ΔPME| of the difference between the increasing rate ΔS of the output of the PM sensor 32 and the increasing rate ΔPME of the engine discharging PM amount is equal to or less than the predetermined value β, it is determined whether the increasing rate ΔS of the output of the PM sensor 32 is within the normal range (range of ΔPME±β).

In Step 210, in a case in which the absolute value |ΔS−ΔPME| of the difference is equal to or less than the predetermined value β, namely the increasing rate ΔS of the output of the PM sensor 32 is within the normal range (range of ΔPME±β), the processing proceeds to Step 211, and it is determined that the PM sensor 32 is normal (the output abnormality of the PM sensor 32 is not occurred).

Contrary to this, in Step 210, in a case in which the absolute value |ΔS−ΔPME| of the difference exceeds the predetermined value β, namely the increasing rate ΔS of the output of the PM sensor 32 is out of the normal range (range of ΔPME±β), the processing proceeds to Step 212, and it is determined that the output abnormality (the linearity abnormality of the output) of the PM sensor 32 is occurred. At this time, in a case in which the increasing rate ΔS of the output of the PM sensor 32 is less than the lower limit (ΔPME−β) of the normal range, it is determined that the increasing rate ΔS of the output of the PM sensor 32 is excessively small and the output abnormality of the PM sensor 32 is occurred. On the other hand, in a case in which the increasing rate ΔS of the output of the PM sensor 32 is more than the upper limit (ΔPME+β) of the normal range, it is determined that the increasing rate ΔS of the output of the PM sensor 32 is excessively large and the output abnormality of the PM sensor 32 is occurred.

In the present embodiment described above, by focusing on that the value of the output of the PM sensor 32 downstream of the one-side blocked filter 31 is larger than “0” (the value corresponding to the amount of the PM flowing out from the one-side blocked filter 31), the first and the second sensor abnormality diagnoses that determine the occurrence of the output abnormality of the PM sensor 32 based on the output of the PM sensor 32 are executed. With this, the occurrence of the output abnormality of the PM sensor 32 can be determined and the output abnormality of the PM sensor 32 can be detected easily.

In the first sensor abnormality diagnosis, the filter-outflow PM amount PMF is estimated based on the working condition of the engine 11 and the PM collection rate of the one-side blocked filter 31, and by comparing the sensor-detection PM amount PMS with the filter-outflow PM amount PMF, the occurrence of the output abnormality of the PM sensor 32 is determined. With this, the occurrence of the output abnormality (the abnormality of the output value) of the PM sensor 32 can be precisely determined.

In the second sensor abnormality diagnosis, the engine discharging PM amount is estimated based on the working condition of the engine 11, and by comparing the increasing rate of the output of the PM sensor 32 with the increasing rate of the engine discharging PM amount, the occurrence of the output abnormality of the PM sensor 32 is determined. With this, the occurrence of the output abnormality (the linearity abnormality of the output) of the PM sensor 32 can be precisely determined.

Further, in the present embodiment, the fuel injection timing of the engine 11 is compulsorily advanced and then the change rate of the output of the PM sensor 32 and the change rate of the engine discharging PM amount are calculated. With such a configuration, when the fuel injection timing of the engine 11 is compulsorily advanced and the amount of the PM discharged from the engine 11 is compulsorily changed, the change rate of the output of the PM sensor 32 and the change rate of the engine discharging PM amount can be calculated. With this, the second sensor abnormality diagnosis can be executed by calculating the change rate of the output of the PM sensor 32 and the change rate of the engine discharging PM amount in a short period of time.

Further, in the present embodiment, the first sensor abnormality diagnosis or the second sensor abnormality diagnosis is executed after the PM accumulation amount in the one-side blocked filter 31 exceeds the predetermined value “A”. With such a configuration, since the sensor abnormality diagnosis can be executed in a state in which the PM collection rate is stable after the PM accumulation amount in the one-side blocked filter 31 exceeds the predetermined value “A”, the sensor abnormality diagnosis can be executed in a state in which the change of the output of the PM sensor 32 caused by the change of the PM collection rate is substantially eliminated, and therefore accuracy in the abnormality diagnosis of the PM sensor 32 can be improved.

Further, in the embodiment described above, in the first sensor abnormality diagnosis, based on whether the absolute value of the difference between the sensor-detection PM amount and the filter-outflow PM amount is equal to or less than the predetermined value, it is determined whether the sensor-detection PM amount is within the normal range. However, it is not limited to this, and for example, based on whether a ratio of the sensor-detection PM amount and the filter-outflow PM amount is within a predetermined range, it may be determined whether the sensor-detection PM amount is within the normal range.

Further, in the embodiment described above, in the second sensor abnormality diagnosis, based on whether the absolute value of the difference between the increasing rate of the output of the PM sensor 32 and the increasing rate of the engine discharging PM amount is equal to or less than the predetermined value, it is determined whether the increasing rate of the output of the PM sensor 32 is within the normal range. However, it is not limited to this, and for example, based on whether a ratio of the increasing rate of the output of the PM sensor 32 and the increasing rate of the engine discharging PM amount is within a predetermined range, it may be determined that the increasing rate of the output of the PM sensor 32 is within the normal range.

Further, in the embodiment described above, in the second sensor abnormality diagnosis, the increasing rate of the output of the PM sensor 32 and the increasing rate of the engine discharging PM amount are compared with each other, however it is not limited to this, and a decreasing rate of the output of the PM sensor 32 and a decreasing rate of the engine discharging PM amount may be compared with each other.

Further, in the embodiment described above, in the second sensor abnormality diagnosis, the fuel injection timing is compulsorily changed and then the change rate of the output of the PM sensor 32 and the change rate of the engine discharging PM amount are calculated. However, it is not limited to this, and for example, a number of divided injections of fuel or fuel pressure may be compulsorily changed, or alternatively two or three elements among the fuel injection timing and the number of the divided injections of fuel and the fuel pressure may be compulsorily changed.

Further, in the second sensor abnormality diagnosis, the change rate of the output of the PM sensor 32 and the change rate of the engine discharging PM amount may be calculated when a working state of the engine is changed according to request or the like of a driver (when the amount of the PM discharged from the engine 11 is changed) instead of compulsorily changing the fuel injection timing, the number of the divided injections of fuel, or the fuel pressure.

Further, in the embodiment described above, the first sensor abnormality diagnosis or the second sensor abnormality diagnosis is executed after the PM accumulation amount in the one-side blocked filter 31 exceeds the predetermined value “A”, however it is not limited to this, and the first sensor abnormality diagnosis or the second sensor abnormality diagnosis may be executed before the PM accumulation amount exceeds the predetermined value “A”.

Further, in the embodiment described above, the system including the one-side blocked filter having the structure in which the inlet side of a part of the cells is blocked and the outlet side of all of the cells is opened is adopted in the present disclosure, however it is not limited to this. A system including a one-side blocked filter having a structure in which the inlet side of a part of the cells is blocked and the outlet side of a part of the remaining cells (cells with the inlet side opened) is blocked may be adopted in the present disclosure. Alternatively, a system including a one-side blocked filter having a structure in which the outlet side of a part of the cells is blocked and the inlet side of all of the cells is opened, or a one-side blocked filter having a structure in which the outlet side of a part of the cells is blocked and the inlet side of a part of the remaining cells (cells with the outlet side opened) is blocked may be adopted in the present disclosure. In other words, a system including a one-side blocked filter having a structure in which both of the inlet side of a part of the cells and the outlet side of a part of the cells are opened can be adopted in the present disclosure.

Further, in the embodiment described above, the system including the direct injection gasoline engine is adopted in the present disclosure, however it is not limited to this. A system including a diesel engine or an intake port injection gasoline engine may be adopted in the present disclosure as long as the system has the one-side blocked filter.

The present disclosure is described based on the embodiment, however the present disclosure is not limited to the embodiment or the structure. The present disclosure includes various modified embodiments or modifications in the equivalent range. In addition, while the various combinations and configurations, other combinations and configurations, including more, less or only a single element, are also within the scope of the present disclosure.

1. An abnormality diagnosis device for a PM sensor comprising:
a one-side blocked filter that collects a particulate matter “PM” in exhaust gas of an internal combustion engine, the one-side blocked filter having a structure in which an inlet side of a part of cells arranged in the filter is blocked and an outlet side of at least of one cell among the remaining cells is opened, or a structure in which the outlet side of a part of the cells is blocked and the inlet side of at least one cell among the remaining cells is opened;
a PM sensor that detects an amount of the PM in the exhaust gas passed through the one-side blocked filter; and
an abnormality diagnosis part that executes a sensor abnormality diagnosis that determines whether an occurrence of output abnormality of the PM sensor exists based on an output of the PM sensor.

2. The abnormality diagnosis device for a PM sensor according to claim 1, further comprising:
an outflow PM amount estimation part that estimates the amount of the PM flowing out from the one-side blocked filter “filter-outflow PM amount”, based on a working condition of the internal combustion engine and a PM collection rate of the one-side blocked filter, wherein
the abnormality diagnosis part executes the sensor abnormality diagnosis by comparing an amount of the PM detected based on the output of the PM sensor “sensor-detection PM amount” with the filter-outflow PM amount estimated by the outflow PM amount estimation part.

3. The abnormality diagnosis device for a PM sensor according to claim 2, wherein
the abnormality diagnosis part determines that the output abnormality of the PM sensor is occurred in a case in which a difference between the sensor-detection PM amount and the filter-outflow PM amount is more than a predetermined value.

4. The abnormality diagnosis device for a PM sensor according to claim 1, further comprising:
a discharging PM amount estimation part that estimates an amount of the PM discharged from the internal combustion engine “internal combustion engine discharging PM amount”, based on a working condition of the internal combustion engine, wherein
the abnormality diagnosis part executes the sensor abnormality diagnosis by comparing a change rate of the output of the PM sensor with a change rate of the internal combustion engine discharging PM amount estimated by the discharging PM amount estimation part.

5. The abnormality diagnosis device for a PM sensor according to claim 4, wherein
the abnormality diagnosis part determines that the output abnormality of the PM sensor is occurred in a case in which a difference between the change rate of the output of the PM sensor and the change rate of the internal combustion engine discharging PM amount is more than a predetermined value.

6. The abnormality diagnosis device for a PM sensor according to claim 4, wherein
the abnormality diagnosis part calculates the change rate of the output of the PM sensor and the change rate of the internal combustion engine discharging PM amount by compulsorily changing at least one of an injection timing of the internal combustion engine, a number of divided injections of fuel, and a fuel pressure.

7. The abnormality diagnosis device for a PM sensor according to claim 1, wherein
the abnormality diagnosis part executes the sensor abnormality diagnosis after a PM accumulation amount in the one-side blocked filter exceeds a predetermined value.
